(19) United States
(12) Patent Application Publication
(10) Pub. No.: US 2025/0113263 A1
(43) Pub. Date: Apr. 3, 2025

(54) INTER-DONOR MIGRATION FOR INTEGRATED ACCESS AND BACKHAUL (IAB) NODES

(71) Applicant: ZTE Corporation, Shenzhen (CN)

(72) Inventors: Ying HUANG, Shenzhen (CN); Lin CHEN, Shenzhen (CN)

(21) Appl. No.: 18/833,222

(22) PCT Filed: Jan. 26, 2022
(86) PCT No.: PCT/CN2022/073916

§ 371 Date: Jul. 25, 2024

(51) Int. Cl. H04W 36/00; H04W 36/08; H04W 40/36

(52) U.S. Cl. CPC H04W 36/0064; H04W 36/0061; H04W 36/087; H04W 40/36

(57) ABSTRACT

Presented are systems, methods, apparatuses, or computer-readable media for migrating integrated access and backhaul (IAB) nodes. A first network node may receive a first message comprising assistance information. The assistance information is associated with a migration of an integrated access and backhaul (IAB) entity.

### CROSS-REFERENCE TO RELATED APPLICATION

The present disclosure is a national stage filing under 35 U.S.C. § 371 of international application number PCT/CN2022/073916 filed Jan. 26, 2022 and entitled “inter-donor migration for integrated access and backhaul (IAB) nodes”, which is incorporated herein by reference in its entirety.

### TECHNICAL FIELD

The disclosure relates generally to wireless communications, including but not limited to systems and methods for performing inter-donor migration for integrated access and backhaul (IAB) nodes.

### BACKGROUND

The standardization organization Third Generation Partnership Project (3GPP) is currently in the process of specifying a new Radio Interface called 5G New Radio (5G NR) as well as a Next Generation Packet Core Network (NG-CN or NGC). The 5G NR will have three main components: a 5G Access Network (5G-AN), a 5G Core Network (5GC), and a User Equipment (UE). In order to facilitate the enablement of different data services and requirements, the elements of the 5GC, also called Network Functions, have been simplified with some of them being software based so that they could be adapted according to need.

### SUMMARY

The example embodiments disclosed herein are directed to solving the issues relating to one or more of the problems presented in the prior art, as well as providing additional features that will become readily apparent by reference to the following detailed description when taken in conjunction with the accompany drawings. In accordance with various embodiments, example systems, methods, devices and computer program products are disclosed herein. It is understood, however, that these embodiments are presented by way of example and are not limiting, and it will be apparent to those of ordinary skill in the art who read the present disclosure that various modifications to the disclosed embodiments can be made while remaining within the scope of this disclosure.

At least one aspect is directed to a system, a method, an apparatus, or a computer-readable medium for migrating integrated access and backhaul (IAB) nodes. A first network node may receive a first message comprising assistance information. The assistance information is associated with a migration of an integrated access and backhaul (IAB) entity.

In some embodiments, the first network node may receive the message from a second network node. In some embodiments, the first network node may receive the message from a third network node. In some embodiments, the first network node may receive the message from the IAB entity.

In some embodiments, the assistance information may include at least one of: an indication for an F1 transport migration, an indication of mobile termination (MT) migration, an indication of handover of an MT of the IAB entity, an identity of a network node which serves the IAB entity, an identity of a target network node of the IAB entity, an identity of a network node to which an F1 transport migration message should be sent, an identity of the MT of the IAB entity, an identity of the IAB entity, or an identity of a distributed unit (DU) of the IAB entity.

In some embodiments, before a third network node sends the first message to the first network node, the third network node may receive a second message from a second network node. The second message may include at least one of: an identity of a network node which serves the IAB entity, an identity of a network node which has an F1 connection with the IAB entity, an identity of an MT of the IAB entity, an identity of the IAB entity, or an identity of a distributed unit (DU) of the IAB entity.

In some embodiments, before the IAB entity sends the first message to the first network node, the IAB entity may receive a third message from a second network node or a third network node. The third message may include at least one of: an identity of a network node which serves the IAB entity, an identity of a target network node of the IAB entity, an identity of a network node to which an F1 transport migration message should be sent, an identity of the IAB entity, or an identity of a distributed unit (DU) of the mobile IAB entity.

In some embodiments, the first network node may send an F1 transport related message to a third network node. In some embodiments, the first network node may send, to the third network node, a F1 transport related request message comprising at least one of: quality of service (QoS) information, an identity of the IAB entity, an identity of a mobile termination (MT) of the IAB entity, an identity of a distributed unit (DU) of the IAB entity, or address information of the IAB entity.

In some embodiments, after sending, by the first network node, the F1 transport related message to the third network node, the first network node may receive, from the third network node, a response message. The response message may include at least one of: an IPv6 flow label (FL) or differentiated services code point (DSCP) value, uplink backhaul information, or a backhaul adaptation protocol (BAP) routing identifier (ID), a next hop BAP address, a backhaul (BH) radio link control (RLC) channel ID, or address information of the IAB entity.

In some embodiments, the first network node may send, to an access and mobility management function (AMF), a first NG application protocol (NGAP) message comprising first information. The first information may include at least one of: quality of service (QoS) information, an identity of the IAB entity, an identity of a distributed unit (DU) of the IAB entity, address information of the IAB entity, an identity of the first network node, an identity of the third network node, an identity of a network node which serves the IAB entity, an identity of a target donor CU of the mobile IAB entity, or an identity of a donor CU to which the F1 transport migration should be sent.

In some embodiments, the third network node may receive from the AMF a second NGAP message comprising second information. The second information may include at least a portion of the first information. In some embodiments, the third network node may send to the AMF a third NGAP message comprising third information. The third information may include at least one of: an IPv6 flow label (FL) or differentiated services code point (DSCP) value, uplink backhaul information, a backhaul adaptation protocol (BAP) routing identifier (ID), a next hop BAP address, a backhaul (BH) radio link control (RLC) channel ID, address information of the IAB entity, or at least a portion of the second information. In some embodiments, the first network node may receive, from the AMF, a message comprising at least a portion of the third information.

In some embodiments, the first network node may send, to a second network node, a first Xn application protocol (XnAP) message comprising first information. The first information may include at least one of: quality of service (QoS) information, an identity of the IAB entity, an identity of a distributed unit (DU) of the IAB entity, address information of the mobile IAB node, an identity of the first network node, an identity of the third network node, an identity of a network node which serves the IAB entity, an identity of a target network node of the IAB entity, or an identity of a network node to which the F1 transport related message should be sent.

In some embodiments, the third network node may receive from the second network node a second XnAP message comprising second information. The second information may include at least a portion of the first information. In some embodiments, the third network node may send to the second network node a third XnAP message comprising third information. The third information may include at least one of: an IPv6 flow label (FL) or differentiated services code point (DSCP) value, uplink backhaul information, a backhaul adaptation protocol (BAP) routing identifier (ID), a next hop BAP address, a backhaul (BH) radio link control (RLC) channel ID, address information of the IAB node, or at least a portion of the second information. In some embodiments, the first network node may receive, from the second network node, a message comprising at least a portion of the third information.

At least one aspect is directed to a system, a method, an apparatus, or a computer-readable medium for migrating integrated access and backhaul (IAB) nodes. A network entity may send, to a first network node, a message comprising assistance information. The assistance information is associated with a migration of an integrated access and backhaul (IAB) entity.

### BRIEF DESCRIPTION OF THE DRAWINGS

Various example embodiments of the present solution are described in detail below with reference to the following figures or drawings. The drawings are provided for purposes of illustration only and merely depict example embodiments of the present solution to facilitate the reader's understanding of the present solution. Therefore, the drawings should not be considered limiting of the breadth, scope, or applicability of the present solution. It should be noted that for clarity and ease of illustration, these drawings are not necessarily drawn to scale.

FIG. 1 illustrates an example cellular communication network in which techniques disclosed herein may be implemented, in accordance with an embodiment of the present disclosure;

FIG. 2 illustrates a block diagram of an example base station and a user equipment device, in accordance with some embodiments of the present disclosure;

FIG. 3 illustrates a block diagram of an environment for a mobile integrated access and backhaul (IAB) in accordance with an illustrative embodiment;

FIG. 4A illustrates a block diagram of an integrated access and backhaul (IAB) architecture using standalone (SA) mode with a next generation core (NGC) in accordance with an illustrative embodiment;

FIG. 4B illustrates a block diagram of an integrated access and backhaul (IAB) architecture using Evolved Universal Mobile Telecommunications System New Radio (EN-DC) in accordance with an illustrative embodiment;

FIG. 5 illustrates a block diagram of integrated access and backhaul (IAB) nodes in a parent and child relationship in accordance with an illustrative embodiment;

FIG. 6A illustrates a block diagram of an integrated access and backhaul (IAB) mobile termination (MT) migrating from a first donor distributed unit (DU1) of a first centralized unit (CU1) to a second donor distributed unit (DU2) of a second donor centralized unit (CU2) in accordance with an illustrative embodiment;

FIG. 6B illustrates a block diagram of an integrated access and backhaul (IAB) mobile termination (MT) migrating from a second donor distributed unit (DU2) of a second donor centralized unit (CU2) to a third donor distributed unit (DU3) of a third donor centralized unite (CU3) in accordance with an illustrative embodiment;

FIG. 6C illustrates a block diagram of an integrated access and backhaul (IAB) distributed unit (DU) migrating from a first donor centralized unit (CU1) to a third donor centralized unit (CU3) in accordance with an illustrative embodiment;

FIG. 7 illustrates a decision tree diagram of migrating integrated access and backhaul (IAB) mobile termination (MT) in accordance with an illustrative embodiment; and

FIG. 8 illustrates of a flow diagram of a method of performing inter-donor migration for integrated access and backhaul (IAB) nodes in accordance with an illustrative embodiment.

### DETAILED DESCRIPTION

Various example embodiments of the present solution are described below with reference to the accompanying figures to enable a person of ordinary skill in the art to make and use the present solution. As would be apparent to those of ordinary skill in the art, after reading the present disclosure, various changes or modifications to the examples described herein can be made without departing from the scope of the present solution. Thus, the present solution is not limited to the example embodiments and applications described and illustrated herein. Additionally, the specific order or hierarchy of steps in the methods disclosed herein are merely example approaches. Based upon design preferences, the specific order or hierarchy of steps of the disclosed methods or processes can be re-arranged while remaining within the scope of the present solution. Thus, those of ordinary skill in the art will understand that the methods and techniques disclosed herein present various steps or acts in a sample order, and the present solution is not limited to the specific order or hierarchy presented unless expressly stated otherwise.

### 1. Mobile Communication Technology and Environment

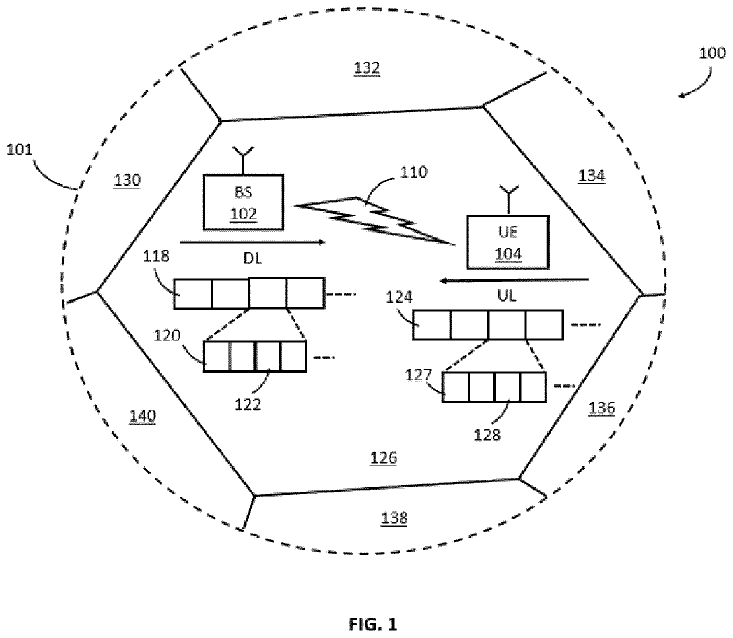

FIG. 1 illustrates an example wireless communication network, and/or system, 100 in which techniques disclosed herein may be implemented, in accordance with an embodiment of the present disclosure. In the following discussion, the wireless communication network 100 may be any wireless network, such as a cellular network or a narrowband Internet of things (NB-IoT) network, and is herein referred to as “network 100.” Such an example network 100 includes a base station 102 (hereinafter “BS 102”; also referred to as wireless communication node) and a user equipment device 104 (hereinafter “UE 104”; also referred to as wireless communication device) that can communicate with each other via a communication link 110 (e.g., a wireless communication channel), and a cluster of cells 126, 130, 132, 134, 136, 138 and 140 overlaying a geographical area 101. In FIG. 1, the BS 102 and UE 104 are contained within a respective geographic boundary of cell 126. Each of the other cells 130, 132, 134, 136, 138 and 140 may include at least one base station operating at its allocated bandwidth to provide adequate radio coverage to its intended users.

For example, the BS 102 may operate at an allocated channel transmission bandwidth to provide adequate coverage to the UE 104. The BS 102 and the UE 104 may communicate via a downlink radio frame 118, and an uplink radio frame 124 respectively. Each radio frame 118/124 may be further divided into sub-frames 120/127 which may include data symbols 122/128. In the present disclosure, the BS 102 and UE 104 are described herein as non-limiting examples of “communication nodes,” generally, which can practice the methods disclosed herein. Such communication nodes may be capable of wireless and/or wired communications, in accordance with various embodiments of the present solution.

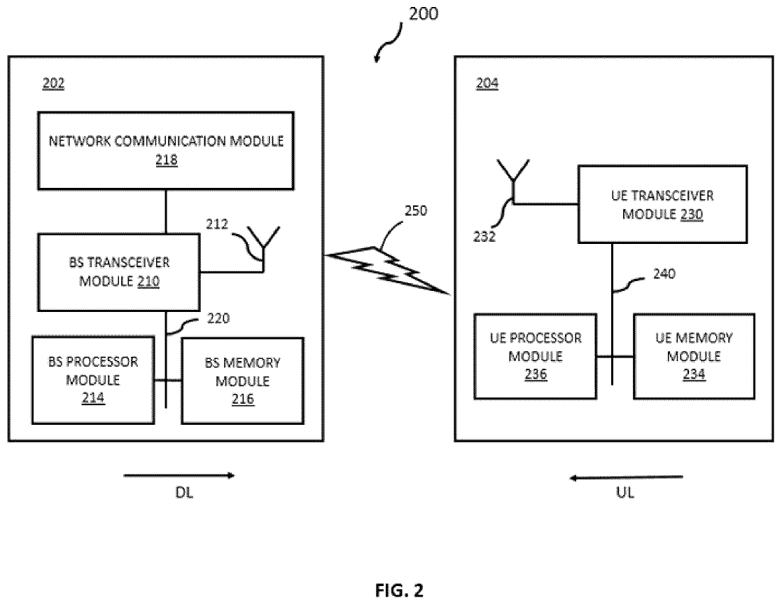

FIG. 2 illustrates a block diagram of an example wireless communication system 200 for transmitting and receiving wireless communication signals (e.g., OFDM/OFDMA signals) in accordance with some embodiments of the present solution. The system 200 may include components and elements configured to support known or conventional operating features that need not be described in detail herein. In one illustrative embodiment, system 200 can be used to communicate (e.g., transmit and receive) data symbols in a wireless communication environment such as the wireless communication environment 100 of FIG. 1, as described above.

System 200 generally includes a base station 202 (hereinafter “BS 202”) and a user equipment device 204 (hereinafter “UE 204”). The BS 202 includes a BS (base station) transceiver module 210, a BS antenna 212, a BS processor module 214, a BS memory module 216, and a network communication module 218, each module being coupled and interconnected with one another as necessary via a data communication bus 220. The UE 204 includes a UE (user equipment) transceiver module 230, a UE antenna 232, a UE memory module 234, and a UE processor module 236, each module being coupled and interconnected with one another as necessary via a data communication bus 240. The BS 202 communicates with the UE 204 via a communication channel 250, which can be any wireless channel or other medium suitable for transmission of data as described herein.

As would be understood by persons of ordinary skill in the art, system 200 may further include any number of modules other than the modules shown in FIG. 2. Those skilled in the art will understand that the various illustrative blocks, modules, circuits, and processing logic described in connection with the embodiments disclosed herein may be implemented in hardware, computer-readable software, firmware, or any practical combination thereof. To clearly illustrate this interchangeability and compatibility of hardware, firmware, and software, various illustrative components, blocks, modules, circuits, and steps are described generally in terms of their functionality. Whether such functionality is implemented as hardware, firmware, or software can depend upon the particular application and design constraints imposed on the overall system. Those familiar with the concepts described herein may implement such functionality in a suitable manner for each particular application, but such implementation decisions should not be interpreted as limiting the scope of the present disclosure

In accordance with some embodiments, the UE transceiver 230 may be referred to herein as an “uplink” transceiver 230 that includes a radio frequency (RF) transmitter and a RF receiver each comprising circuitry that is coupled to the antenna 232. A duplex switch (not shown) may alternatively couple the uplink transmitter or receiver to the uplink antenna in time duplex fashion. Similarly, in accordance with some embodiments, the BS transceiver 210 may be referred to herein as a “downlink” transceiver 210 that includes a RF transmitter and a RF receiver each comprising circuity that is coupled to the antenna 212. A downlink duplex switch may alternatively couple the downlink transmitter or receiver to the downlink antenna 212 in time duplex fashion. The operations of the two transceiver modules 210 and 230 may be coordinated in time such that the uplink receiver circuitry is coupled to the uplink antenna 232 for reception of transmissions over the wireless transmission link 250 at the same time that the downlink transmitter is coupled to the downlink antenna 212. Conversely, the operations of the two transceivers 210 and 230 may be coordinated in time such that the downlink receiver is coupled to the downlink antenna 212 for reception of transmissions over the wireless transmission link 250 at the same time that the uplink transmitter is coupled to the uplink antenna 232. In some embodiments, there is close time synchronization with a minimal guard time between changes in duplex direction.

The UE transceiver 230 and the base station transceiver 210 are configured to communicate via the wireless data communication link 250, and cooperate with a suitably configured RF antenna arrangement 212/232 that can support a particular wireless communication protocol and modulation scheme. In some illustrative embodiments, the UE transceiver 210 and the base station transceiver 210 are configured to support industry standards such as the Long Term Evolution (LTE) and emerging 5G standards, and the like. It is understood, however, that the present disclosure is not necessarily limited in application to a particular standard and associated protocols. Rather, the UE transceiver 230 and the base station transceiver 210 may be configured to support alternate, or additional, wireless data communication protocols, including future standards or variations thereof.

In accordance with various embodiments, the BS 202 may be an evolved node B (eNB), a serving eNB, a target eNB, a femto station, or a pico station, for example. In some embodiments, the UE 204 may be embodied in various types of user devices such as a mobile phone, a smart phone, a personal digital assistant (PDA), tablet, laptop computer, wearable computing device, etc. The processor modules 214 and 236 may be implemented, or realized, with a general purpose processor, a content addressable memory, a digital signal processor, an application specific integrated circuit, a field programmable gate array, any suitable programmable logic device, discrete gate or transistor logic, discrete hardware components, or any combination thereof, designed to perform the functions described herein. In this manner, a processor may be realized as a microprocessor, a controller, a microcontroller, a state machine, or the like. A processor may also be implemented as a combination of computing devices, e.g., a combination of a digital signal processor and a microprocessor, a plurality of microprocessors, one or more microprocessors in conjunction with a digital signal processor core, or any other such configuration.

Furthermore, the steps of a method or algorithm described in connection with the embodiments disclosed herein may be embodied directly in hardware, in firmware, in a software module executed by processor modules 214 and 236, respectively, or in any practical combination thereof. The memory modules 216 and 234 may be realized as RAM memory, flash memory, ROM memory, EPROM memory, EEPROM memory, registers, a hard disk, a removable disk, a CD-ROM, or any other form of storage medium known in the art. In this regard, memory modules 216 and 234 may be coupled to the processor modules 210 and 230, respectively, such that the processors modules 210 and 230 can read information from, and write information to, memory modules 216 and 234, respectively. The memory modules 216 and 234 may also be integrated into their respective processor modules 210 and 230. In some embodiments, the memory modules 216 and 234 may each include a cache memory for storing temporary variables or other intermediate information during execution of instructions to be executed by processor modules 210 and 230, respectively. Memory modules 216 and 234 may also each include non-volatile memory for storing instructions to be executed by the processor modules 210 and 230, respectively.

The network communication module 218 generally represents the hardware, software, firmware, processing logic, and/or other components of the base station 202 that enable bi-directional communication between base station transceiver 210 and other network components and communication nodes configured to communication with the base station 202. For example, network communication module 218 may be configured to support internet or WiMAX traffic. In a typical deployment, without limitation, network communication module 218 provides an 802.3 Ethernet interface such that base station transceiver 210 can communicate with a conventional Ethernet based computer network. In this manner, the network communication module 218 may include a physical interface for connection to the computer network (e.g., Mobile Switching Center (MSC)). The terms “configured for,” “configured to” and conjugations thereof, as used herein with respect to a specified operation or function, refer to a device, component, circuit, structure, machine, signal, etc., that is physically constructed, programmed, formatted and/or arranged to perform the specified operation or function.

The Open Systems Interconnection (OSI) Model (referred to herein as, “open system interconnection model”) is a conceptual and logical layout that defines network communication used by systems (e.g., wireless communication device, wireless communication node) open to interconnection and communication with other systems. The model is broken into seven subcomponents, or layers, each of which represents a conceptual collection of services provided to the layers above and below it. The OSI Model also defines a logical network and effectively describes computer packet transfer by using different layer protocols. The OSI Model may also be referred to as the seven-layer OSI Model or the seven-layer model. In some embodiments, a first layer may be a physical layer. In some embodiments, a second layer may be a Medium Access Control (MAC) layer. In some embodiments, a third layer may be a Radio Link Control (RLC) layer. In some embodiments, a fourth layer may be a Packet Data Convergence Protocol (PDCP) layer. In some embodiments, a fifth layer may be a Radio Resource Control (RRC) layer. In some embodiments, a sixth layer may be a Non Access Stratum (NAS) layer or an Internet Protocol (IP) layer, and the seventh layer being the other layer.

### 2. Systems and Methods for Performing Inter-Donor Migration FO Integrated Access and Backhaul Nodes (IAB)

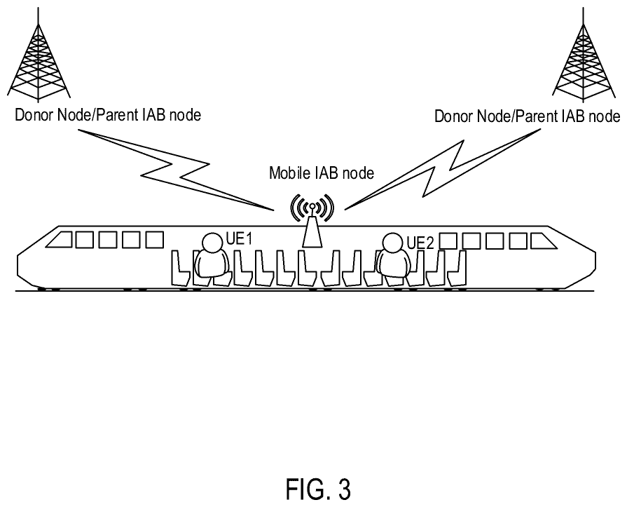

Referring now to FIG. 3, depicted is a block diagram of an environment for a mobile integrated access and backhaul (IAB). An Integrated Access and Backhaul (IAB) may support wireless backhauling via new radio (NR) enabling flexible and very dense deployment of NR cells while reducing the need for wireline transport infrastructure. Intra-donor centralized unit (CU) migration procedure (e.g., as specified in R16 IAB) may be provided in which both the source and the target parent node are served by the same IAB-donor-CU. The inter-donor CU migration in the migrating IAB node, however, may be static. It may be difficult to perform inter-donor migration in a mobile IAB use scenario as depicted. In mobile IAB use case, IAB nodes are mounted in vehicles and can provide coverage and capacity enhancement to onboard or surrounding user equipment (UEs).

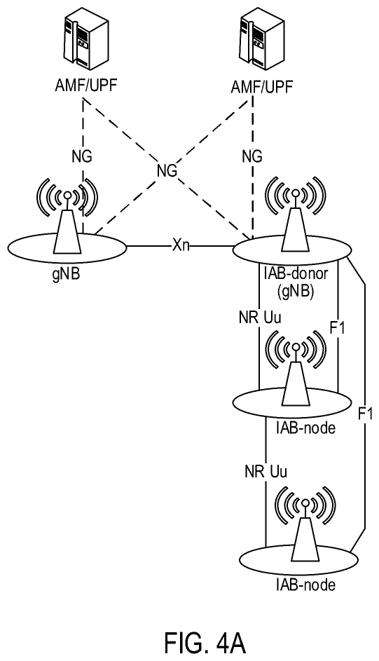

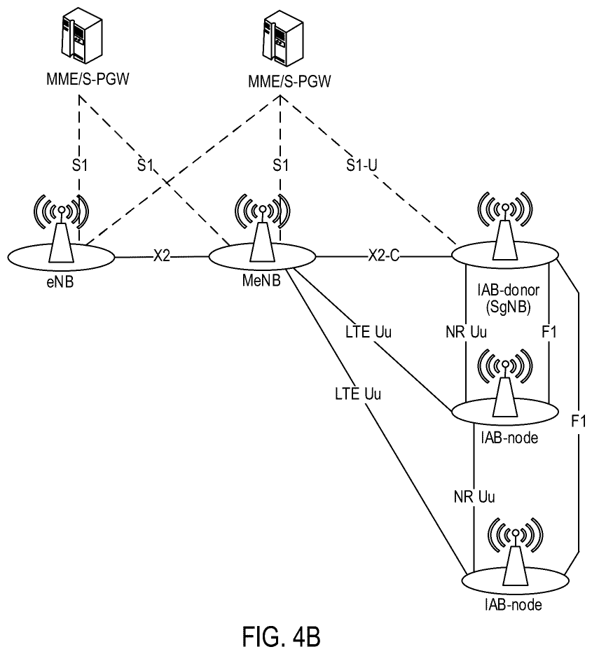

Referring now to FIG. 4A, depicted is a block diagram of an integrated access and backhaul (IAB) architecture using standalone (SA) mode with a next generation core (NGC). The integrated access and backhaul (IAB) can enable wireless relaying in NG-RAN. The relaying node, referred to as IAB-node, may support access and backhauling via NR. The terminating node of NR backhauling on network side may be referred to as the IAB-donor, which represents a gNB with additional functionality to support IAB. Backhauling can occur via a single or via multiple hops.

The IAB-node may support gNB-DU functionality (e.g., as defined in TS 38.401), to terminate the NR access interface to UEs and next-hop IAB-nodes, and to terminate the F1 protocol to the gNB-CU functionality, on the IAB-donor. The gNB-DU functionality on the IAB-node may be also referred to as IAB distributed unit (DU) (IAB-DU). In addition to the gNB-DU functionality, the IAB-node may also support a subset of the UE functionality referred to as IAB-mobile termination (MT), which includes, e.g., physical layer, layer-2, radio resource control (RRC) and non-access stratum (NAS) functionality to connect to the gNB-DU of another IAB-node or the IAB-donor, to connect to the gNB-CU on the IAB-donor, and to the core network, among others.

Referring now to FIG. 4B, depicted is a block diagram of an integrated access and backhaul (IAB) architecture using Evolved Universal Mobile Telecommunications System New Radio (EN-DC). The IAB-node can access the network using either SA-mode or EN-DC. In EN-DC, the IAB-node also connects via E-UTRA to a MeNB, and the IAB-donor terminates X2-C as SgNB (e.g., as defined in TS 37.340).

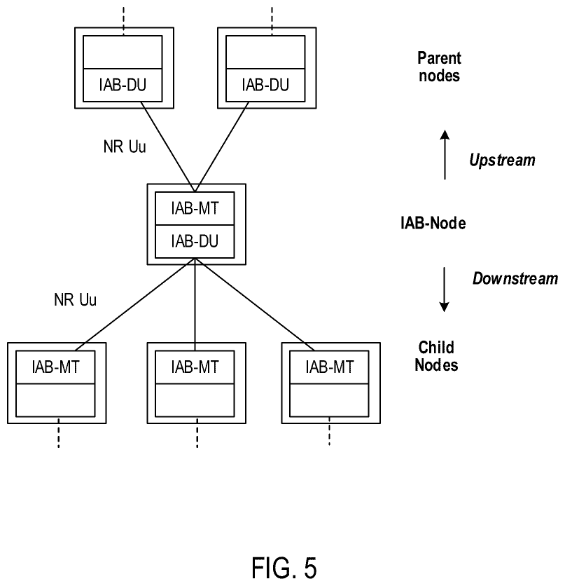

Referring now to FIG. 5, depicted is a block diagram of integrated access and backhaul (IAB) nodes in a parent and child relationship. All IAB-nodes that are connected to an IAB-donor via one or multiple hops can form a directed acyclic graph (DAG) topology with the IAB-donor at its root. In this DAG topology, the neighbor node on the IAB-DU's interface may be referred to as child node and the neighbor node on the IAB-MT's interface is referred to as parent node. The direction toward the child node may be further referred to as downstream while the direction toward the parent node is referred to as upstream. The IAB-donor may perform centralized resource, topology and route management for the IAB topology.

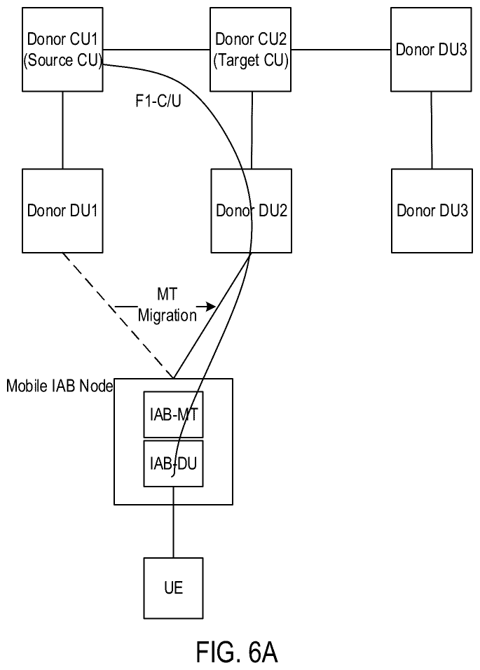

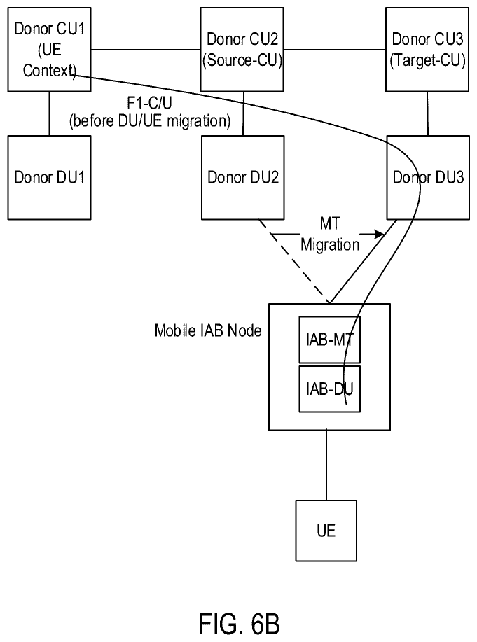

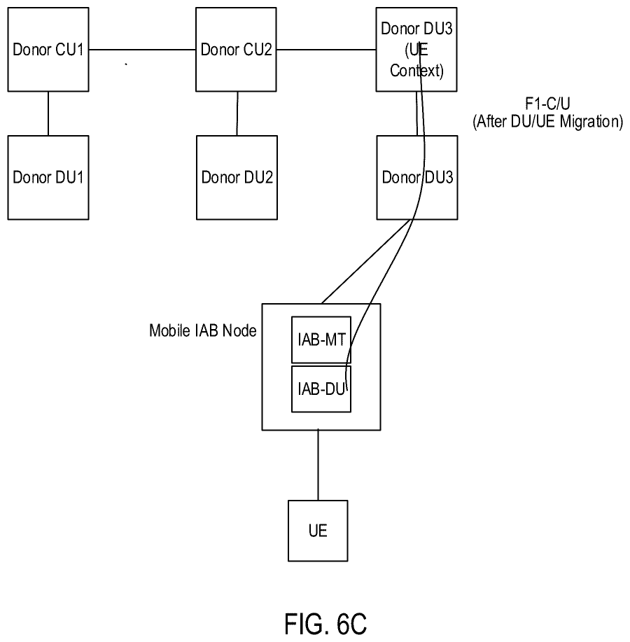

Referring to FIG. 6A, depicted is a block diagram of an integrated access and backhaul (IAB) mobile termination (MT) migrating from a first donor distributed unit (DU1) of a first centralized unit (CU1) to a second donor distributed unit (DU2) of a second donor centralized unit (CU2). As depicted, the mobile IAB-MT may migrate from donor DU1 which belongs to donor CU1 to donor DU2 which belongs to donor CU2. The mobile IAB-DU, however, may maintain its F1 connection with donor CU1 and UE context remains in donor CU1. F1-C/U traffic between donor CU1 and mobile IAB-DU may be transmitted via donor DU2.

Referring to FIG. 6B, depicted is a block diagram of an integrated access and backhaul (IAB) mobile termination (MT) migrating from a second donor distributed unit (DU2) of a second donor centralized unit (CU2) to a third donor distributed unit (DU3) of a third donor centralized unite (CU3). As depicted, mobile IAB-MT may migrate from donor DU2 which belongs to donor CU2 to donor DU3 which belongs to donor CU3. The mobile IAB-DU, however, may maintain its F1 connection with donor CU1 and UE context remains in donor CU1. F1-C/U traffic between donor CU1 and mobile IAB-DU may be transmitted via donor DU3.

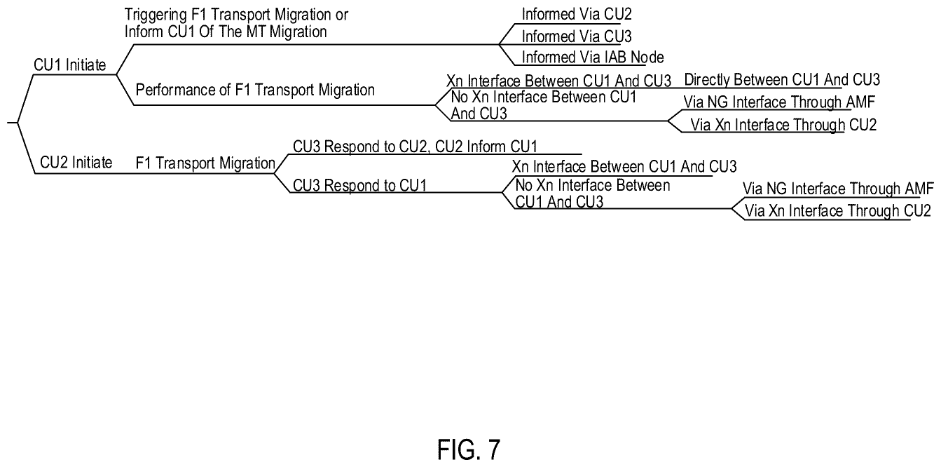

Referring to FIG. 6C, depicted is a block diagram of an integrated access and backhaul (IAB) distributed unit (DU) migrating from a first donor centralized unit (CU1) to a third donor centralized unit (CU3). As depicted, the mobile IAB-DU may migrate from donor CU1 to donor CU3. The UE may be handed over from donor CU1 to donor CU3. F1-C/U traffic between donor CU3 and mobile IAB-DU may be transmitted via donor DU3. Referring to FIG. 7, depicted is a decision tree diagram of migrating integrated access and backhaul (IAB) mobile termination (MT). Various branches are detailed herein below.

### A. Triggering F1 Transport Migration or Informing CU1 of MT Migration

During MT migration, mobile IAB-MT disconnects with the source donor DU and connects to the target donor DU. After MT migration, F1 transport may be migrated from source path to target path. In order to perform the F1 transport migration, transport information may be transmitted to the donor CU3. The F1 transport migration may be triggered, or CU1 of the MT migration may be informed.

### I. Informing via CU2

First, during or after mobile IAB-MT migrates to donor DU3, CU2 may send assistance information to CU1 (e.g. via XnAP message). The assistance information includes at least one of the following: F1 transport migration indication; MT migration indication; identity of source or donor CU which serves the mobile IAB-MT; identity of target donor CU of the mobile IAB-MT; identity of target or donor CU which the F1 transport migration should be sent to; identity of the mobile IAB-MT; and identity of the mobile IAB-DU, among others. In some embodiments, CU2 can send assistance information to CU1 via UE associated XnAP message. In some embodiments, CU2 can send assistance information to CU1 via non-UE associated XnAP message. Second, CU1 can initiate the F1 transport migration procedure or update procedure to CU3.

### II. Informing via CU3

First, CU2 may send the first assistance information to CU3, e.g. via XnAP handover request message. The first assistance information includes at least one of the following: identity of donor CU which serves the mobile IAB-DU; identity of the mobile IAB-MT; and identity of the mobile IAB-DU, among others. Second, CU3 may send the second assistance information to CU1, e.g. via UE associated or non-UE associated XnAP message. The second assistance information includes at least one of the following: F1 transport migration indication; MT migration indication; identity of donor CU which serves the mobile IAB-MT; identity of target donor CU of the mobile IAB-MT; identity of donor CU which the F1 transport migration should be sent to; identity of the mobile IAB-MT; and identity of the mobile IAB-DU, among others. Third, CU1 can initiate the F1 transport migration or update procedure to CU3.

### III. Informing via IAB Node

First, the mobile IAB node receives the first assistance information (e.g. via RRC message). The first assistance information may include at least one of the following: identity of donor CU which serves the mobile IAB-MT; identity of target donor CU of the mobile IAB-MT; identity of donor CU which the F1 transport migration should be sent to; identity of the mobile IAB-MT allocated by the target donor; and identity of the mobile IAB-DU allocated by the target donor, among others.

Second, the mobile IAB node sends the second assistance information to CU1 (e.g. via F1AP message). The second assistance information includes at least one of the following: F1 transport migration indication; MT migration indication; identity of donor CU which serves the mobile IAB-MT; identity of target donor CU of the mobile IAB-MT; identity of donor CU which the F1 transport migration should be sent to; identity of the mobile IAB-MT; and identity of the mobile IAB-DU, among others.

Third, CU1 initiates the F1 transport migration or update procedure to CU3.

### B. Performing F1 Transport Migration via CU1 Initiation

During MT migration, mobile IAB-MT may disconnect with the source donor DU and connects to the target donor DU. After MT migration, F1 transport may be migrated from source path to target path. The F1 transport migration procedure or update procedure may be performed.

### I. With Xn Interface Between CU1 and CU3, F1 Transport Migration or Update Procedure Performed Directly Between CU1 and CU3 via XnAP Messages

First, CU1 may send F1 transport migration request information to CU3, e.g. via UE associated or non UE associated XnAP message. The F1 transport migration request information may include at least one of the following: Quality of service (QoS) information (e.g. QoS information of F1-C/F1-U traffic to be migrated); identity of the mobile IAB-MT; identity of the mobile IAB-DU; and Internet Protocol (IP) address information of the mobile IAB node (e.g. IPv4 address, IPv6 address, IPv6 prefix, the usage of the IP address (for F1-C/F1-U/non F1)), among others. The IP address information may be IP addresses allocated by CU1 or allocated by CU3.

Second, CU3 may send response message to CU1. The response message may include at least one of the following: IPv6 FL differentiated services code point (DSCP) value; Uplink backhaul (UL BH) information (e.g., backhaul adaptation protocol (BAP) routing ID, next hop BAP address, BH RLC channel ID; and IP address information of the mobile IAB node (e.g., IPv4 address, IPv6 address, IPv6 prefix, the usage of the IP address (for F1-C/F1-U/non F1), among others. The IP address information may include IP addresses allocated by CU1 or allocated by CU3.

### II. With No Xn Interface Between CU1 and CU3, F1 Transport Migration Performed via NG Interface Through Access and Mobility Management Function (AMF)

First, CU1 may send NG application protocol (NGAP) message to AMF. The NGAP message may include at least one of the following: QoS information (e.g., QoS information of F1-C/F1-U traffic to be migrated); identity of the mobile IAB-MT; identity of the mobile IAB-DU; IP address information of the mobile IAB node (e.g. IPv4 address, IPv6 address, IPv6 prefix, the usage of the IP address (for F1-C/F1-U/non F1) allocated by CU1 or allocated by CU3; identity of CU1; identity of CU3; identity of donor CU which serves the mobile IAB-MT; identity of target donor CU of the mobile IAB-MT; and identity of donor CU which the F1 transport migration should be sent to, among others. Second, AMF may send NGAP message to CU3. The NGAP message may include at least one of the following: QoS information (e.g. QoS information of F1-C/F1-U traffic to be migrated); identity of the mobile IAB-MT; identity of the mobile IAB-DU; IP address information of the mobile IAB node (e.g. IPv4 address, IPv6 address, IPv6 prefix, the usage of the IP address (for F1-C/F1-U/non F1) allocated by CU1 or allocated by CU3; identity of CU1; identity of CU3; identity of donor CU which serves the mobile IAB-MT; identity of target donor CU of the mobile IAB-MT; and identity of donor CU which the F1 transport migration should be sent to, among others.

Third, CU3 may send NGAP message to the AMF. The NGAP message may include at least one of the following: IPv6 FL/DSCP value; Uplink (UL) backhaul (BH) information (e.g., BAP routing ID, next hop BAP address, BH RLC channel ID); identity of the mobile IAB-MT; identity of the mobile IAB-DU; IP address information of the mobile IAB node (e.g., IPv4 address, IPv6 address, IPv6 prefix, and the usage of the IP address (for F1-C/F1-U/non F1)) allocated by CU1 or allocated by CU3; identity of CU1; and identity of CU3, among others.

Fourth, the AMF may send NGAP message to CU1. The NGAP message may include at least one of the following: IPv6 FL/DSCP value; UL BH information (e.g. BAP routing ID, next hop BAP address, BH radio link control (RLC) channel ID); identity of the mobile IAB-MT; identity of the mobile IAB-DU; IP address information of the mobile IAB node (e.g., IPv4 address, IPv6 address, IPv6 prefix, the usage of the IP address (for F1-C/F1-U/non F1)) allocated by CU1 or allocated by CU3; identity of CU1; and identity of CU3, among others.

### III With No Xn Interface Between CU1 and CU3, F1 Transport Migration Performed via Xn Interface Through CU2

First, CU1 may send XnAP message to CU2. The XnAP message may include at least one of the following: QoS information (e.g. QoS information of F1-C/F1-U traffic to be migrated); identity of the mobile IAB-MT; identity of the mobile IAB-DU; IP address information of the mobile IAB node (e.g. IPv4 address, IPv6 address, IPv6 prefix, and the usage of the IP address (for F1-C/F1-U/non F1)) allocated by CU1 or allocated by CU3; identity of CU1; identity of CU3; identity of donor CU which serves the mobile IAB-MT; identity of target donor CU of the mobile IAB-MT; and identity of donor CU which the F1 transport migration should be sent to, among others.

Second, CU2 may send XnAP message to CU3. The XnAP message may include at least one of the following: QoS information (e.g. QoS information of F1-C/F1-U traffic to be migrated); identity of the mobile IAB-MT; identity of the mobile IAB-DU; IP address information of the mobile IAB node (e.g. IPv4 address, IPv6 address, IPv6 prefix, and the usage of the IP address (for F1-C/F1-U/non F1)) allocated by CU1 or allocated by CU3; identity of CU1; identity of CU3; identity of donor CU which serves the mobile IAB-MT; identity of target donor CU of the mobile IAB-MT; and identity of donor CU which the F1 transport migration should be sent to, among others.

Third, CU3 may send XnAP message to the CU2. The XnAP message may include at least one of the following: IPv6 FL/DSCP value; UL BH information (e.g., BAP routing ID, next hop BAP address, and BH radio link control (RLC) channel ID); identity of the mobile IAB-MT; identity of the mobile IAB-DU; IP address information of the mobile IAB node (e.g. IPv4 address, IPv6 address, IPv6 prefix, and the usage of the IP address (for F1-C/F1-U/non F1) allocated by CU1 or allocated by CU3; identity of CU1; and identity of CU3, among others.

Fourth, the CU2 may send XnAP message to CU1. The XnAP message may include at least one of the following IPv6 FL/DSCP value; UL BH information (e.g., BAP routing ID, next hop BAP address, and BH RLC channel ID.; identity of the mobile IAB-MT; identity of the mobile IAB-DU; IP address information of the mobile IAB node (e.g. IPv4 address, IPv6 address, IPv6 prefix, and the usage of the IP address (for F1-C/F1-U/non F1)) allocated by CU1 or allocated by CU3; identity of CU1; and identity of CU3, among others.

### C. Performing F1 Transport Migration via CU2

During MT migration, mobile IAB-MT may disconnect with the source donor DU and connect to the target donor DU. After MT migration, F1 transport may be migrated from source path to target path. In order to perform the F1 transport migration, transport information may be transmitted to the donor CU3. The F1 transport migration may be triggered, or CU1 may be informed of the MT migration.

First, during or after the migration of the mobile MT, CU2 may initiate the F1 transport migration or update procedure. CU2 may send XnAP message to CU3. The XnAP message may include at least one of the following: QoS information (e.g. QoS information of F1-C/F1-U traffic to be migrated); identity of the mobile IAB-MT; identity of the mobile IAB-DU; IP address information of the mobile IAB node (e.g., IPv4 address, IPv6 address, IPv6 prefix, and the usage of the IP address (for F1-C/F1-U/non F1)) allocated by CU1 or allocated by CU3; identity of CU1; identity of CU3; identity of donor CU which serves the mobile IAB-MT; identity of target donor CU of the mobile IAB-MT; and identity of donor CU which the F1 transport migration should be sent to, among others.

Second, CU3 may send XnAP message to CU2. The XnAP message may include at least one of the following: IPv6 FL/DSCP value; UL BH information (e.g. BAP routing ID, next hop BAP address, and BH RLC channel ID); identity of the mobile IAB-MT; identity of the mobile IAB-DU; IP address information of the mobile IAB node (e.g., IPv4 address, IPv6 address, IPv6 prefix, the usage of the IP address (for F1-C/F1-U/non F1)) allocated by CU1 or allocated by CU3; identity of CU1; and identity of CU3, among others.

Third, CU2 may send XnAP message to CU1. The XnAP message may include at least one of the following: IPv6 FL/DSCP value; UL BH information (e.g., BAP routing ID, next hop BAP address, and BH RLC channel ID); identity of the mobile IAB-MT; identity of the mobile IAB-DU; IP address information of the mobile IAB node (e.g., IPv4 address, IPv6 address, IPv6 prefix, and the usage of the IP address (for F1-C/F1-U/non F1)) allocated by CU1 or allocated by CU3; identity of CU1; identity of CU3; F1 transport migration indication; and MT migration indication, among others.

### D. Performing F1 Transport Migration With CU3 Responding to CU1

During MT migration, mobile IAB-MT may disconnect with the source donor DU and may connect to the target donor DU. After MT migration, F1 transport may be migrated from source path to target path. In order to perform the F1 transport migration, transport information may be transmitted to the donor CU3. The F1 transport migration may be triggered or CU1 may be informed of the MT migration.

First, during or after the migration of the mobile MT, CU2 may initiates the F1 transport migration or update procedure. CU2 may send XnAP message to CU3. The XnAP message may include at least one of the following: QoS information, e.g. QoS information of F1-C/F1-U traffic to be migrated; identity of the mobile IAB-MT; identity of the mobile IAB-DU; IP address information of the mobile IAB node (e.g. IPv4 address, IPv6 address, IPv6 prefix, and the usage of the IP address (for F1-C/F1-U/non F1)) allocated by CU1 or allocated by CU3; identity of CU1; identity of CU3; identity of donor CU which serves the mobile IAB-MT; identity of donor CU which serves the mobile IAB-DU; identity of target donor CU of the mobile IAB-MT; and identity of donor CU which the F1 transport migration should be sent to, among others.

Second, CU3 may send response information to CU1. The response information may include at least one of the following: IPv6 FL/DSCP value; UL BH information, e.g. BAP routing ID, next hop BAP address, BH RLC channel ID; identity of the mobile IAB-MT; identity of the mobile IAB-DU; IP address information of the mobile IAB node (e.g. IPv4 address, IPv6 address, IPv6 prefix, and the usage of the IP address (for F1-C/F1-U/non F1)) allocated by CU1 or allocated by CU3; identity of CU1; and identity of CU3, among others.

If there is Xn interface between CU1 and CU3, the response message may be transferred directly between CU1 and CU3 via Xn interface. On the other hand, if there is no Xn interface between CU1 and CU3, the response message may be transferred via following methods. In some embodiments, the response message may be transferred via NG interface through AMF. First, CU3 may send the response message to AMF. Second, AMF may send the response message to CU1. In some embodiments, the response message may be transferred via Xn interface through CU2. First, CU3 may send the response message to CU2. CU2 may send the response message to CU1.

### E. Process for Performing Inter-Donor Migration for Integrated Access and Backhaul (IAB) Nodes

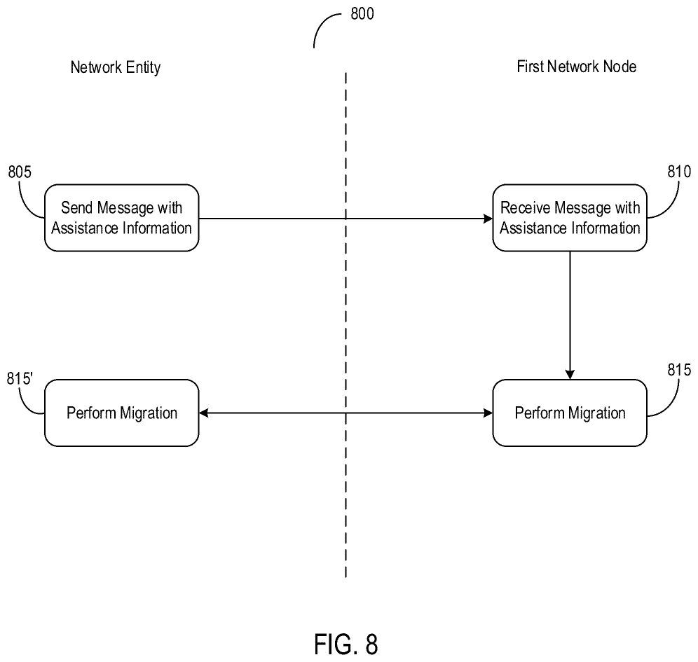

Referring now to FIG. 8, depicted is a flow diagram of a method 800 of performing inter-donor migration for integrated access and backhaul (IAB) nodes. The method 800 may be implemented using or performed by any of the components detailed above, such as the UE 104 or 204 and BS 102 or 202, among others. In overview, a network entity may send a message with assistance information (805). The first network node may receive the message with the assistance information (810). The first network node and the network entity may perform migration (815 and 815′).

In further detail, a network entity may provide, transmit, or otherwise send a message with assistance information to a first network node (e.g., donor CU1) (805). The message may identify or include the assistance information. The assistant information may be associated with a migration of an integrated access and backhaul (IAB) entity. The network entity may be a second network node (e.g., CU2), a third network node (e.g., CU3), or the integrated access and backhaul (IAB) entity (e.g., a mobile IAB node), among others.

The network entity and the first network node may correspond to one or more of the following. The IAB donor may include gNB that provides network access to UEs via a network of backhaul and access links. The IAB donor CU may include the gNB-CU of an IAB-donor, terminating the F1 interface towards IAB-nodes and IAB-donor-DU. IAB-donor-DU may include a gNB-DU of an IAB-donor, hosting the IAB BAP sublayer, providing wireless backhaul to IAB-nodes. The IAB-DU may include gNB-DU functionality supported by the IAB-node to terminate the NR access interface to UEs and next-hop IAB-nodes, and to terminate the F1 protocol to the gNB-CU functionality on the IAB-donor.

Continuing on, an IAB-MT may include an IAB-node function that terminates the Uu interface to the parent node using the procedures and behaviors specified for UEs unless stated otherwise. IAB-MT function may correspond to IAB-UE function. An IAB-node may include an radio access network (RAN) node that supports NR access links to UEs and NR backhaul links to parent nodes and child nodes. The IAB-node may not support backhauling via a long term evolution (LTE). A child node may include IAB-DU's and IAB-donor-DU's next hop neighbor node. The child node may also an IAB-node. A Parent node may include an IAB-MT's next hop neighbor node. The parent node can be IAB-node or IAB-donor-DU. Upstream may correspond to a direction toward parent node in IAB-topology. Downstream may correspond to a direction toward child node or UE in IAB-topology.

In some embodiments, the network entities may communicate one or more messages with one or another, prior to the sending of the message to the first network node. In some embodiments, before the third network node sends the message to the first network node, the third network node may retrieve, identify, or otherwise receive a second message. The second message may identify or include an identity of a network node which serves the IAB entity, an identity of a network node which has an F1 connection with the IAB entity, an identity of an MT of the IAB entity, an identity of the IAB entity, or an identity of a distributed unit (DU) of the IAB entity, among others.

In some embodiments, before the IAB entity sends the first message to the first network node, the IAB entity may retrieve, identify, or receive a third message from a second network node or a third network node. The third message may include at least one of: an identity of a network node which serves the IAB entity, an identity of a target network node of the IAB entity, an identity of a network node to which an F1 transport migration message should be sent, an identity of the IAB entity, or an identity of a distributed unit (DU) of the mobile IAB entity, among others.

The first network node (e.g., donor CU1) may identify, retrieve, or otherwise receive the message with the assistance information from the network entity (810). The network entity from which the first network node receives the message may be from one of a variety of sources. In some embodiments, the first network node may receive the message from the second network node (e.g., CU2, when migration is from CU2 to CU3). In some embodiments, the first network node may receive the message from the third network node (e.g., CU3, when the migration is from CU3 to CU2). In some embodiments, the first network node may receive the message from the IAB entity.

With receipt, the first network node may parse the message to extract or identify the assistance information. In some embodiments, the assistance information may include one or more of: an indication for an F1 transport migration, an indication of mobile termination (MT) migration, an indication of handover of an MT of the IAB entity, an identity of a network node which serves the IAB entity, an identity of a target network node of the IAB entity, an identity of a network node to which an F1 transport migration message should be sent, an identity of the MT of the IAB entity, an identity of the IAB entity, or an identity of a distributed unit (DU) of the IAB entity, among others.

The first network node and the network entity may or carry out perform migration in accordance with the assistance information of the message (815 and 815′). In performing migration, the first network node and the network entities may communicate one or more messages. In some embodiments, the messages may be in accordance with F1 transport migration. In some embodiments, the first network node may transmit, provide, or otherwise send an F1 transport related message to the network entity, such as the third network node. In some embodiments, the first network node may transmit, provide, or otherwise send a F1 transport related request message to the third network node. The F1 transport related request message may identify or include one or more of: quality of service (QoS) information, an identity of the IAB entity, an identity of a mobile termination (MT) of the IAB entity, an identity of a distributed unit (DU) of the IAB entity, or address information of the IAB entity, among others.

Continuing on, in some embodiments, after the first network node sends the F1 transport related message to the third message, the first network node may retrieve, identify, or otherwise receive a response message. The response message may identify or include one or more of: an IPv6 flow label (FL) or differentiated services code point (DSCP) value, uplink backhaul information, or a backhaul adaptation protocol (BAP) routing identifier (ID), a next hop BAP address, a backhaul (BH) radio link control (RLC) channel ID, or address information of the IAB entity, among others.

In some embodiments, the messages communicated may be in accordance with an NG application protocol (NGAP). In some embodiments, the first network node may transmit, provide, or otherwise send a first NGAP message. The first NGAP message may identify or include first information. The first information may identify or include one or more of: quality of service (QoS) information, an identity of the IAB entity, an identity of a distributed unit (DU) of the IAB entity, address information of the IAB entity, an identity of the first network node, an identity of the third network node, an identity of a network node which serves the IAB entity, an identity of a target donor CU of the mobile IAB entity, or an identity of a donor CU to which the F1 transport migration should be sent, among others.

Continuing on, in some embodiments, the third network node may retrieve, identify, or otherwise receive a second NGAP message from an access and mobility management function (AMF). The second NGAP message may identify or include second information. The second information may identify or include at least a portion of the first information. In some embodiments, the third network may provide, transmit, or otherwise send a third NGAP message to the AMF. The third NGAP message may identify or include third information. The third information may identify or include one or more of: an IPv6 flow label (FL) or differentiated services code point (DSCP) value, uplink backhaul information, a backhaul adaptation protocol (BAP) routing identifier (ID), a next hop BAP address, a backhaul (BH) radio link control (RLC) channel ID, or address information of the IAB entity, among others. In some embodiments, the third information may identify or include at least a portion of the second information. In some embodiments, the first network node may retrieve, identify, or otherwise receive a message from the AMF. The message may identify or include at least a portion of the third information.

In some embodiments, the messages communicated may be in accordance with an Xn application protocol (XnAP). In some embodiments, the first network node may provide, transmit, or otherwise send a first XnAP message. The first XnAP message may identify or include first information. The first information may identify or include one or more of: quality of service (QoS) information, an identity of the IAB entity, an identity of a distributed unit (DU) of the IAB entity, address information of the mobile IAB node, an identity of the first network node, an identity of the third network node, an identity of a network node which serves the IAB entity, an identity of a target network node of the IAB entity, or an identity of a network node to which the F1 transport related message should be sent, among others.

Continuing on, in some embodiments, the third network node may retrieve, identify, or otherwise receive a second XnAP message from the second network node. The second XnAP message may identify or include second information. The second information may identify or include at least a portion of the first information. In some embodiments, the third network node may transmit, provide, or otherwise send a third XnAP message. The XnAP message may identify or include third information. The third information may identify or include one or more of: an IPv6 flow label (FL) or differentiated services code point (DSCP) value, uplink backhaul information, a backhaul adaptation protocol (BAP) routing identifier (ID), a next hop BAP address, a backhaul (BH) radio link control (RLC) channel ID, or address information of the IAB node, among others. In some embodiments, the third information may identify or include at least a portion of the second information. In some embodiments, the first network node may retrieve, identify, or otherwise receive a message from the second network node. The message may identify or include at least a portion of the third information.

While various embodiments of the present solution have been described above, it should be understood that they have been presented by way of example only, and not by way of limitation. Likewise, the various diagrams may depict an example architectural or configuration, which are provided to enable persons of ordinary skill in the art to understand example features and functions of the present solution. Such persons would understand, however, that the solution is not restricted to the illustrated example architectures or configurations, but can be implemented using a variety of alternative architectures and configurations. Additionally, as would be understood by persons of ordinary skill in the art, one or more features of one embodiment can be combined with one or more features of another embodiment described herein. Thus, the breadth and scope of the present disclosure should not be limited by any of the above-described illustrative embodiments.

It is also understood that any reference to an element herein using a designation such as “first,” “second,” and so forth does not generally limit the quantity or order of those elements. Rather, these designations can be used herein as a convenient means of distinguishing between two or more elements or instances of an element. Thus, a reference to first and second elements does not mean that only two elements can be employed, or that the first element must precede the second element in some manner.

Additionally, a person having ordinary skill in the art would understand that information and signals can be represented using any of a variety of different technologies and techniques. For example, data, instructions, commands, information, signals, bits and symbols, for example, which may be referenced in the above description can be represented by voltages, currents, electromagnetic waves, magnetic fields or particles, optical fields or particles, or any combination thereof.

A person of ordinary skill in the art would further appreciate that any of the various illustrative logical blocks, modules, processors, means, circuits, methods and functions described in connection with the aspects disclosed herein can be implemented by electronic hardware (e.g., a digital implementation, an analog implementation, or a combination of the two), firmware, various forms of program or design code incorporating instructions (which can be referred to herein, for convenience, as “software” or a “software module), or any combination of these techniques. To clearly illustrate this interchangeability of hardware, firmware and software, various illustrative components, blocks, modules, circuits, and steps have been described above generally in terms of their functionality. Whether such functionality is implemented as hardware, firmware or software, or a combination of these techniques, depends upon the particular application and design constraints imposed on the overall system. Skilled artisans can implement the described functionality in various ways for each particular application, but such implementation decisions do not cause a departure from the scope of the present disclosure.

Furthermore, a person of ordinary skill in the art would understand that various illustrative logical blocks, modules, devices, components and circuits described herein can be implemented within or performed by an integrated circuit (IC) that can include a general purpose processor, a digital signal processor (DSP), an application specific integrated circuit (ASIC), a field programmable gate array (FPGA) or other programmable logic device, or any combination thereof. The logical blocks, modules, and circuits can further include antennas and/or transceivers to communicate with various components within the network or within the device. A general purpose processor can be a microprocessor, but in the alternative, the processor can be any conventional processor, controller, or state machine. A processor can also be implemented as a combination of computing devices, e.g., a combination of a DSP and a microprocessor, a plurality of microprocessors, one or more microprocessors in conjunction with a DSP core, or any other suitable configuration to perform the functions described herein.

If implemented in software, the functions can be stored as one or more instructions or code on a computer-readable medium. Thus, the steps of a method or algorithm disclosed herein can be implemented as software stored on a computer-readable medium. Computer-readable media includes both computer storage media and communication media including any medium that can be enabled to transfer a computer program or code from one place to another. A storage media can be any available media that can be accessed by a computer. By way of example, and not limitation, such computer-readable media can include RAM, ROM, EEPROM, CD-ROM or other optical disk storage, magnetic disk storage or other magnetic storage devices, or any other medium that can be used to store desired program code in the form of instructions or data structures and that can be accessed by a computer.

In this document, the term “module” as used herein, refers to software, firmware, hardware, and any combination of these elements for performing the associated functions described herein. Additionally, for purpose of discussion, the various modules are described as discrete modules; however, as would be apparent to one of ordinary skill in the art, two or more modules may be combined to form a single module that performs the associated functions according embodiments of the present solution.

Additionally, memory or other storage, as well as communication components, may be employed in embodiments of the present solution. It will be appreciated that, for clarity purposes, the above description has described embodiments of the present solution with reference to different functional units and processors. However, it will be apparent that any suitable distribution of functionality between different functional units, processing logic elements or domains may be used without detracting from the present solution. For example, functionality illustrated to be performed by separate processing logic elements, or controllers, may be performed by the same processing logic element, or controller. Hence, references to specific functional units are only references to a suitable means for providing the described functionality, rather than indicative of a strict logical or physical structure or organization.

Various modifications to the embodiments described in this disclosure will be readily apparent to those skilled in the art, and the general principles defined herein can be applied to other embodiments without departing from the scope of this disclosure. Thus, the disclosure is not intended to be limited to the embodiments shown herein, but is to be accorded the widest scope consistent with the novel features and principles disclosed herein, as recited in the claims below.

1. A method, comprising:
receiving, by a first network node, a first message comprising assistance information,
wherein the assistance information is associated with a migration of an integrated access and backhaul (IAB) entity.

2. The method of claim 1, comprising:
receiving, by the first network node, the message from a second network node.

3. The method of claim 1, comprising:
receiving, by the first network node, the message from a third network node.

4. The method of claim 1, comprising:
receiving, by the first network node, the message from the IAB entity.

5. The method of claim 2, wherein the assistance information comprises at least one of:
an indication for an F1 transport migration,
an indication of mobile termination (MT) migration,
an indication of handover of an MT of the IAB entity,
an identity of a network node which serves the IAB entity,
an identity of a target network node of the IAB entity,
an identity of a network node to which an F1 transport migration message should be sent,
an identity of the MT of the IAB entity,
an identity of the IAB entity, or
an identity of a distributed unit (DU) of the IAB entity.

6. The method of claim 3, wherein before a third network node sends the first message to the first network node, the third network node receives a second message from a second network node, the second message comprising at least one of:
an identity of a network node which serves the IAB entity,
an identity of a network node which has an F1 connection with the IAB entity,
an identity of an MT of the IAB entity,
an identity of the IAB entity, or
an identity of a distributed unit (DU) of the IAB entity.

7. The method of claim 4, wherein before the IAB entity sends the first message to the first network node, the IAB entity receives a third message from a second network node or a third network node, the third message comprising at least one of:
an identity of a network node which serves the IAB entity,
an identity of a target network node of the IAB entity,
an identity of a network node to which an F1 transport migration message should be sent,
an identity of the IAB entity, or
an identity of a distributed unit (DU) of the mobile IAB entity.

8. The method of claim 1, comprising:
sending, by the first network node, an F1 transport related message to a third network node.

9. The method of claim 8, comprising:
sending, by the first network node to the third network node, a F1 transport related request message comprising at least one of:
quality of service (QoS) information,
an identity of the IAB entity,
an identity of a mobile termination (MT) of the IAB entity,
an identity of a distributed unit (DU) of the IAB entity, or
address information of the IAB entity.

10. The method of claim 9, comprising:
after sending, by the first network node, the F1 transport related message to the third network node, receiving, by the first network node from the third network node, a response message comprising at least one of: an IPv6 flow label (FL) or differentiated services code point (DSCP) value,
uplink backhaul information, or
a backhaul adaptation protocol (BAP) routing identifier (ID),
a next hop BAP address,
a backhaul (BH) radio link control (RLC) channel ID, or
address information of the IAB entity.

11. The method of claim 8, comprising:
sending, by the first network node to an access and mobility management function (AMF), a first NG application protocol (NGAP) message comprising first information, the first information comprising at least one of:
quality of service (QoS) information,
an identity of the IAB entity,
an identity of a distributed unit (DU) of the IAB entity,
address information of the IAB entity,
an identity of the first network node,
an identity of the third network node,
an identity of a network node which serves the IAB entity,
an identity of a target donor CU of the mobile IAB entity, or
an identity of a donor CU to which the F1 transport migration should be sent.

12. The method of claim 11, wherein the third network node receives from the AMF a second NGAP message comprising second information, the second information comprising at least a portion of the first information.

13. The method of claim 12, wherein the third network node sends to the AMF a third NGAP message comprising third information, the third information comprising at least one of:
an IPv6 flow label (FL) or differentiated services code point (DSCP) value,
uplink backhaul information,
a backhaul adaptation protocol (BAP) routing identifier (ID),
a next hop BAP address,
a backhaul (BH) radio link control (RLC) channel ID,
address information of the IAB entity, or
at least a portion of the second information.

14. The method of claim 13, comprising:
receiving, by the first network node from the AMF, a message comprising at least a portion of the third information.

15. The method of claim 8, comprising:
sending, by the first network node to a second network node, a first Xn application protocol (XnAP) message comprising first information, the first information comprising at least one of:
quality of service (QoS) information,
an identity of the IAB entity,
an identity of a distributed unit (DU) of the IAB entity,
address information of the mobile IAB node,
an identity of the first network node,
an identity of the third network node,
an identity of a network node which serves the IAB entity,
an identity of a target network node of the IAB entity, or
an identity of a network node to which the F1 transport related message should be sent.

16. The method of claim 15, wherein the third network node receives from the second network node a second XnAP message comprising second information, the second information comprising at least a portion of the first information.

17. The method of claim 16, wherein the third network node sends to the second network node a third XnAP message comprising third information, the third information comprising at least one of:
an IPv6 flow label (FL) or differentiated services code point (DSCP) value,
uplink backhaul information,
a backhaul adaptation protocol (BAP) routing identifier (ID),
a next hop BAP address,
a backhaul (BH) radio link control (RLC) channel ID,
address information of the IAB node, or
at least a portion of the second information; and
the method further comprising: receiving, by the first network node from the second network node, a message comprising at least a portion of the third information.

18. (canceled)

19. A method, comprising:
sending, by a network entity to a first network node, a message comprising assistance information,
wherein the assistance information is associated with a migration of an integrated access and backhaul (IAB) entity.

20. A non-transitory computer readable storage medium storing instructions, which when executed by one or more processors can cause the one or more processors to perform the method of claim 1.

21. A device comprising at least one processor configured to implement the method of claim 1.
